(19) United States
(12) Patent Application Publication
(10) Pub. No.: US 2019/0380016 A1
(43) Pub. Date: Dec. 12, 2019

(54) ELECTRONIC APPARATUS AND METHOD FOR PROVIDING INFORMATION FOR A VEHICLE

(71) Applicant: LG Electronics Inc., Seoul (KR)

(72) Inventor: JaeHwan YOON, Seoul (KR)

(21) Appl. No.: 16/551,089

(22) Filed: Aug. 26, 2019

(30) Foreign Application Priority Data
Jul. 25, 2019 (KR) 10-2019-0090242

(51) Int. Cl. H04W 4/46; H04W 4/44; H04W 4/024; G01C 21/36; G05D 1/00

(52) U.S. Cl. CPC H04W 4/46; H04W 4/44; G05D 1/0027; G01C 21/3602; H04W 4/024

(57) ABSTRACT

Disclosed are a method of providing a second vehicle with a traveling image of a first vehicle which has first traveled in the same route within the same time zone and an electronic apparatus for the same. One or more of an electronic apparatus, a vehicle, and an autonomous vehicle disclosed here is connectable to, for example, an artificial intelligence module, an unmanned aerial vehicle (UAV), a robot, an augmented reality (AR) device, a virtual reality (VR) device, or a 5G service device.

### CROSS-REFERENCE TO RELATED APPLICATION

This application is based on and claims priority under 35 U.S.C. § 119(a) to Korean Patent Application No. 10-2019-0090242, filed on Jul. 25, 2019, the disclosure of which is incorporated herein in its entirety by reference.

### BACKGROUND

### 1. Field

The present disclosure relates to an electronic apparatus and a method of providing information to a vehicle. More particularly, the present disclosure relates to an electronic apparatus and a method which may provide a vehicle with image information for driving assistance.

### 2. Description of the Related Art

In general, when a vehicle is traveling on a road, a driver of the vehicle may refer to a navigation system which operates in the vehicle. Such a navigation system, however, guides the driver the way with a consistent image regardless of an actual traveling environment, which may cause the driver of the vehicle to experience discomfort. For example, since the volume of traffic may change over time even on the same road, but the navigation system guides the way with a consistent image of the road, the driver of the vehicle cannot check a traffic congestion situation on the road in advance. Therefore, there is a need to guide the driver of the vehicle the way in consideration of an actual traveling environment.

In addition, an autonomous vehicle refers to a vehicle equipped with an autonomous driving device which is capable of recognizing the environment around the vehicle and the vehicle condition and thus, controlling the driving of the vehicle. With the progress of autonomous vehicle researches, various services which may increase user convenience using an autonomous vehicle are also being studied.

### SUMMARY

The foregoing summary is illustrative only and is not intended to be in any way limiting. In addition to the illustrative aspects, embodiments, and features described above, further aspects, embodiments, and features will become apparent by reference to the drawings and the following detailed description.

Embodiments disclosed here are devised to provide an electronic apparatus and a method of providing information to a vehicle. Technical subjects to be achieved by the embodiments are not limited to the above-described technical subject, and other technical subjects may be analogized from the following embodiments.

A method of providing information to a vehicle from an electronic apparatus according to one embodiment of the present disclosure includes acquiring a traveling image of a first vehicle associated with traveling at an intersection in a first route, and providing the traveling image of the first vehicle to a second vehicle when the second vehicle is traveling at the intersection in the first route within a predetermined time after the first vehicle has traveled at the intersection.

An electronic apparatus that provides information to a vehicle according to another embodiment includes a communication unit that communicates with a first vehicle and a second vehicle, and a controller that acquires a traveling image of the first vehicle associated with traveling at an intersection in a first route through the communication unit, and provides the traveling image of the first vehicle to the second vehicle when the second vehicle is traveling at the intersection in the first route within a predetermined time after the first vehicle has traveled at the intersection.

A terminal that assists driving of a vehicle according to a further embodiment includes a communication unit that communicates with an external electronic apparatus and a controller that acquires a traveling image of another vehicle associated with traveling at an intersection in a first route through the communication unit when the vehicle is traveling at the intersection in the first route within a predetermined time after the other vehicle has traveled at the intersection, and controls a display unit of the vehicle to display the traveling image of the other vehicle.

A computer readable recording medium according to another aspect includes a non-volatile recording medium storing a program for executing the above-described method in a computer.

Details of other embodiments are included in the following detailed description and the drawings.

Embodiments of the present disclosure provide one or more of the following effects.

First, when a specific vehicle is going to travel at an intersection, by providing the specific vehicle with a traveling image of another vehicle which has first traveled at the intersection in the same route within the same time zone, a driver of the specific vehicle may conveniently receive guidance on the intersection. For example, when traffic congestion occurs at the intersection, the driver of the specific vehicle may correct a traveling route by checking the traveling image of the other vehicle which has first traveled at the intersection, thereby avoiding the traffic congestion.

Second, when the specific vehicle is an autonomous vehicle, the specific vehicle may autonomously travel with reference to a traveling image of another vehicle which has traveled in the same route as an expected traveling route within the same time zone. For example, the specific vehicle may check traffic congestion with reference to the traveling image of the other vehicle which has traveled in the same route as the expected traveling route and thus, may correct a part of the expected traveling route during traveling.

Effects of the present disclosure are not limited to the effects mentioned above, and other unmentioned effects may be clearly understood by those skilled in the art from a description of the claims.

### BRIEF DESCRIPTION OF THE DRAWINGS

The above and other aspects, features, and advantages of certain embodiments will be more apparent from the following detailed description taken in conjunction with the accompanying drawings, in which:

FIG. 1 illustrates an example of a basic operation of an autonomous vehicle and a 5G network in a 5G communication system.

FIG. 2 illustrates an example of an application operation of an autonomous vehicle and a 5G network in a 5G communication system.

FIGS. 3 to 6 illustrate examples of an autonomous vehicle operation using 5G communication.

FIG. 7 illustrates an example of an operation of an electronic apparatus which provides information to a vehicle.

FIG. 8 illustrates a flowchart of a method of providing information to a vehicle from an electronic apparatus.

FIG. 9 illustrates a flowchart of a method of acquiring a traveling image of a vehicle by an electronic apparatus.

FIG. 10 illustrates a concrete embodiment in which an infrastructure acquires a traveling image of a vehicle.

FIG. 11 illustrates a flowchart of a method of providing a traveling image of a vehicle from an electronic apparatus.

FIG. 12 illustrates a concrete embodiment in which an infrastructure provides a traveling image of a vehicle.

FIG. 13 illustrates a flowchart of registering a vehicle as a registration vehicle for a service by an electronic apparatus.

FIG. 14 illustrates a concrete embodiment in which an infrastructure registers a vehicle as a registration vehicle for a service.

FIG. 15 illustrates a block diagram of an electronic apparatus which provides information to a vehicle.

FIG. 16 illustrates a block diagram of a terminal which assists vehicle driving.

FIG. 17 illustrates an AI device according to an embodiment.

FIG. 18 illustrates an AI server according to an embodiment.

FIG. 19 illustrates an AI system according to an embodiment.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

The terms used in the embodiments are selected, as much as possible, from general terms that are widely used at present while taking into consideration the functions obtained in accordance with the present disclosure, but these terms may be replaced by other terms based on intentions of those skilled in the art, customs, emergency of new technologies, or the like. Also, in a particular case, terms that are arbitrarily selected by the applicant of the present disclosure may be used. In this case, the meanings of these terms may be described in corresponding description parts of the disclosure. Accordingly, it should be noted that the terms used herein should be construed based on practical meanings thereof and the whole content of this specification, rather than being simply construed based on names of the terms.

In the entire specification, when an element is referred to as “including” another element, the element should not be understood as excluding other elements so long as there is no special conflicting description, and the element may include at least one other element. In addition, the terms “unit” and “module”, for example, may refer to a component that exerts at least one function or operation, and may be realized in hardware or software, or may be realized by combination of hardware and software.

In addition, in this specification, “artificial Intelligence (AL)” refers to the field of studying artificial intelligence or a methodology capable of making the artificial intelligence, and “machine learning” refers to the field of studying methodologies that define and solve various problems handled in the field of artificial intelligence. The machine learning is also defined as an algorithm that enhances performance for a certain operation through a steady experience with respect to the operation.

An “artificial neural network (ANN)” may refer to a general model for use in the machine learning, which is composed of artificial neurons (nodes) forming a network by synaptic connection and has problem solving ability. The artificial neural network may be defined by a connection pattern between neurons of different layers, a learning process of updating model parameters, and an activation function of generating an output value.

The artificial neural network may include an input layer and an output layer, and may selectively include one or more hidden layers. Each layer may include one or more neurons, and the artificial neural network may include a synapse that interconnects neurons. In the artificial neural network, each neuron may output the value of an activation function concerning signals input through the synapse, weights, and deflection thereof.

The model parameters refer to parameters determined by learning, and include weights for synaptic connection and deflection of neurons, for example. Then, hyper-parameters refer to parameters to be set before learning in a machine learning algorithm, and include a learning rate, the number of repetitions, the size of a mini-batch, and an initialization function, for example.

It can be said that the purpose of learning of the artificial neural network is to determine a model parameter that minimizes a loss function. The loss function may be used as an index for determining an optimal model parameter in a learning process of the artificial neural network.

The machine learning may be classified, according to a learning method, into supervised learning, unsupervised learning, and reinforcement learning.

The supervised learning refers to a learning method for an artificial neural network in the state in which a label for learning data is given. The label may refer to a correct answer (or a result value) to be deduced by the artificial neural network when learning data is input to the artificial neural network. The unsupervised learning may refer to a learning method for the artificial neural network in the state in which no label for learning data is given. The reinforcement learning may refer to a learning method in which an agent defined in a certain environment learns to select a behavior or a behavior sequence that maximizes cumulative compensation in each state.

The machine learning realized by a deep neural network (DNN) including multiple hidden layers among artificial neural networks is also called deep learning, and the deep learning is a part of the machine learning. In the following description, the machine learning is used as a meaning including the deep learning.

In addition, in this specification, a vehicle may be an autonomous vehicle. “Autonomous driving” refers to a self-driving technology, and an “autonomous vehicle” refers to a vehicle that performs driving without a user's operation or with a user's minimum operation. In addition, the autonomous vehicle may refer to a robot having an autonomous driving function.

For example, autonomous driving may include all of a technology of maintaining the lane in which a vehicle is driving, a technology of automatically adjusting a vehicle speed such as adaptive cruise control, a technology of causing a vehicle to automatically drive in a given route, and a technology of automatically setting a route, along which a vehicle drives, when a destination is set.

Here, a vehicle may include all of a vehicle having only an internal combustion engine, a hybrid vehicle having both an internal combustion engine and an electric motor, and an electric vehicle having only an electric motor, and may be meant to include not only an automobile but also a train and a motorcycle, for example.

In the following description, embodiments of the present disclosure will be described in detail with reference to the drawings so that those skilled in the art can easily carry out the present disclosure. The present disclosure may be embodied in many different forms and is not limited to the embodiments described herein.

Hereinafter, embodiments of the present disclosure will be described in detail with reference to the drawings.

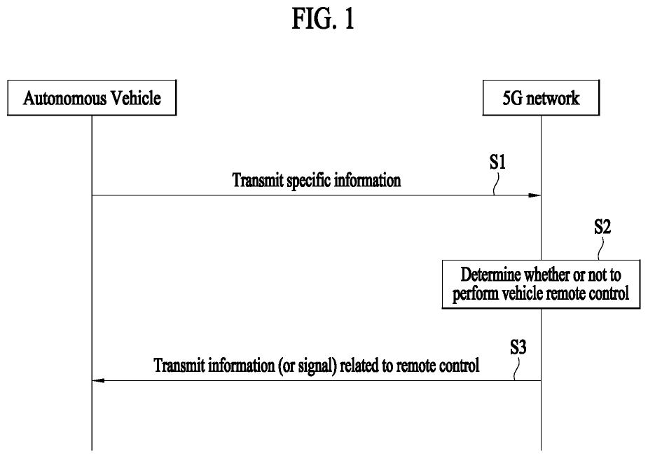

FIG. 1 illustrates an example of a basic operation of an autonomous vehicle and a 5G network in a 5G communication system.

In step S1, the autonomous vehicle transmits specific information to the 5G network which is based on a fifth generation cellular network technology.

The specific information may include information related to autonomous driving.

The information related to autonomous driving may be information that is directly related to vehicle driving control. For example, the information related to autonomous driving may include at least one of object data indicating an object around a vehicle, map data, vehicle state data, vehicle location data, and driving plan data. The information related to autonomous driving may further include, for example, service information required for autonomous driving.

In step S2, the 5G network may determine whether or not to perform vehicle remote control. Here, the 5G network may be connected to a server or a module which performs remote control related to autonomous driving, or may include such a server or module.

In step S3, the 5G network may transmit information (or signals) related to remote control to the autonomous vehicle.

As described above, the information related to remote control may be signals directly applied to the autonomous vehicle, and may further include service information required for autonomous driving. In an embodiment of the present disclosure, the autonomous vehicle may provide the server connected to the 5G network with a traveling image related to traveling at an intersection in a first route, and may receive a traveling image of another vehicle, which has traveled in the first route, from the server connected to the 5G network.

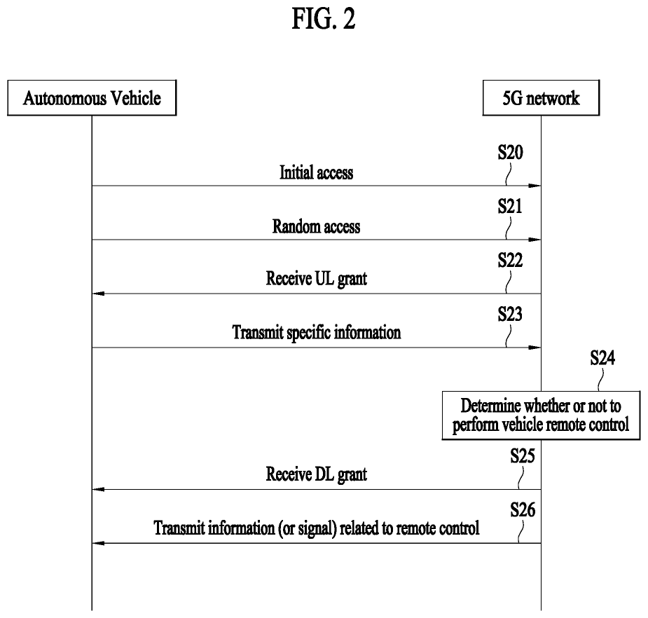

Hereinafter, a process required for 5G communication between an autonomous vehicle and a 5G network (for example, an initial access process between the vehicle and the 5G network) will be schematically described with reference to FIGS. 2 to 6, in order to provide or receive a traveling image for a specific route.

FIG. 2 illustrates an example of an application operation of an autonomous vehicle and a 5G network in a 5G communication system.

In step S20, the autonomous vehicle performs an initial access process with the 5G network.

The initial access process includes, for example, a cell search process for the acquisition of a downlink (DL) operation and a process of acquiring system information.

In step S21, the autonomous vehicle performs a random access process with the 5G network.

The random access process includes, for example, preamble transmission and random access response reception processes for the acquisition of uplink (UL) synchronization or the transmission of UL data.

In step S22, the 5G network transmits an UL grant for scheduling the transmission of specific information to the autonomous vehicle (S22).

The reception of the UR grant includes a process of receiving a time and frequency resource schedule for the transmission of UL data to the 5G network.

In step S23, the autonomous vehicle transmits specific information to the 5G network based on the UL grant.

In step S24, the 5G network determines whether or not to perform vehicle remote control.

In step S25, the autonomous vehicle receives a DL grant from the 5G network through a physical downlink control channel in order to receive a response to the specific information.

In step S26, the 5G network transmits information (or signals) related to remote control to the autonomous vehicle based on the DL grant.

It is to be noted that, in FIG. 2, an example in which the initial access process and/or the random access process and the downlink grant reception process of the communication between the autonomous vehicle and the 5G network are combined with each other has been described by way of example via steps S20 to S26, but the present disclosure is not limited thereto.

For example, the initial access process and/or the random access process may be performed through steps S20, S22, S23, S24 and S25. In addition, the initial access process and/or the random access process may be performed through steps S21, S22, S23, S24 and S26. In addition, a process of combining an AI operation and the downlink grant reception process with each other may be performed through steps S23, S24, S25 and S26.

In addition, it is to be noted that, in FIG. 2, an autonomous vehicle operation has been described by way of example through steps S20 to S26, and the present disclosure is not limited thereto.

For example, an autonomous vehicle operation may be realized by selectively combining steps S20, S21, S22 and S25 with steps S23 and S26. In addition, for example, an autonomous vehicle operation may be composed of steps S21, S22, S23 and S26. In addition, for example, an autonomous vehicle operation may be composed of steps S20, S21, S23 and S26. In addition, for example, an autonomous vehicle operation may be composed of steps S22, S23, S25 and S26.

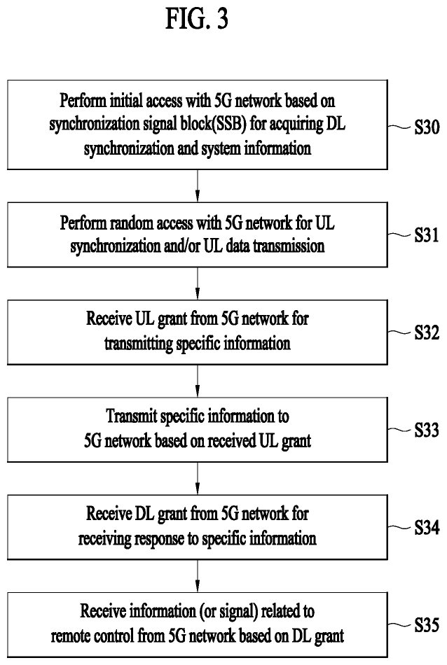

FIGS. 3 to 6 illustrate examples of an autonomous vehicle operation using 5G communication.

First, referring to FIG. 3, in step S30, an autonomous vehicle including an autonomous driving module performs an initial access process with a 5G network based on a synchronization signal block (SSB) to acquire DL synchronization and system information.

In step S31, the autonomous vehicle performs a random access process with the 5G network to acquire UL synchronization and/or to transmit UL data.

In step S32, the autonomous vehicle receives an UL grant from the 5G network in order to transmit specific information.

In step S33, the autonomous vehicle transmits specific information to the 5G network based on the UL grant.

In step S34, the autonomous vehicle receives a DL grant from the 5G network in order to receive a response to the specific information.

In step S35, the autonomous vehicle receives information (or signals) related to remote control from the 5G network based on the DL grant.

A beam management (BM) process may be added to step S30, and a beam failure recovery process related to the transmission of a physical random access channel (PRACH) may be added to step S31. A quasi co-located (QCL) relationship may be added to step S32 with regard to the beam reception direction of a physical downlink control channel (PDCCH). The QCL relationship may also be added to step S33 with regard to the beam transmission direction of a physical uplink control channel (PUCCH) and a physical uplink shared channel (PUSCH). In addition, the QCL relationship may also be added to step S34 with regard to the beam reception direction of a PDCCH including a DL grant.

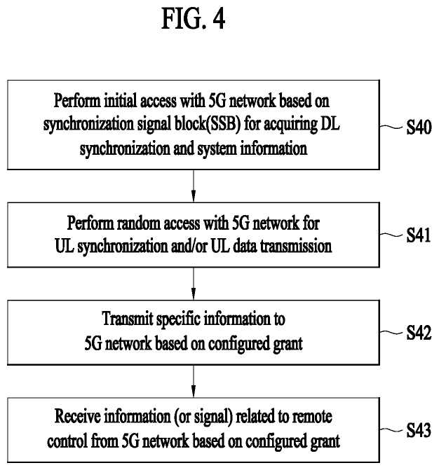

Referring to FIG. 4, in step S40, the autonomous vehicle performs an initial access process with the 5G network based on an SSB to acquire DL synchronization and system information.

In step S41, the autonomous vehicle performs a random access process with the 5G network to acquire UL synchronization and/or to transmit UL data.

In step S42, the autonomous vehicle transmits specific information to the 5G network based on a configured grant.

In step S43, the autonomous vehicle receives information (or signals) related to remote control from the 5G network based on the configured grant.

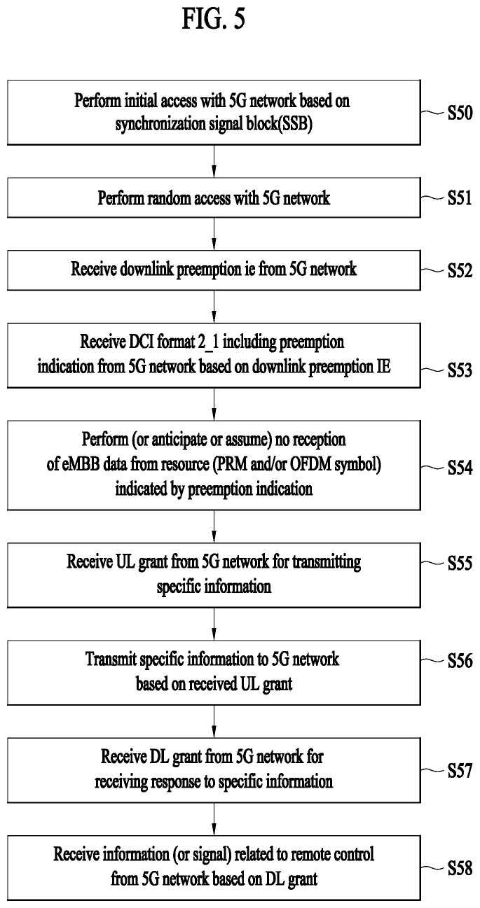

Referring to FIG. 5, in step S50, the autonomous vehicle performs an initial access process with the 5G network based on an SSB to acquire DL synchronization and system information.

In step S51, the autonomous vehicle performs a random access process with the 5G network to acquire UL synchronization and/or to transmit UL data.

In step S52, the autonomous vehicle receives a downlink preemption IE from the 5G network.

In step S53, the autonomous vehicle receives a DCI format 2_1 including a preemption indication from the 5G network based on the downlink preemption IE.

In step S54, the autonomous vehicle does not perform (or anticipate or assume) reception of eMBB data from a resource (PRB and/or OFDM symbols) indicated by the preemption indication.

In step S55, the autonomous vehicle receives an UL grant from the 5G network in order to transmit specific information.

In step S56, the autonomous vehicle transmits specific information to the 5G network based on the UL grant.

In step S57, the autonomous vehicle receives a DL grant from the 5G network in order to receive a response to the specific information.

In step S58, the autonomous vehicle receives information (or signals) related to remote control from the 5G network based on the DL grant.

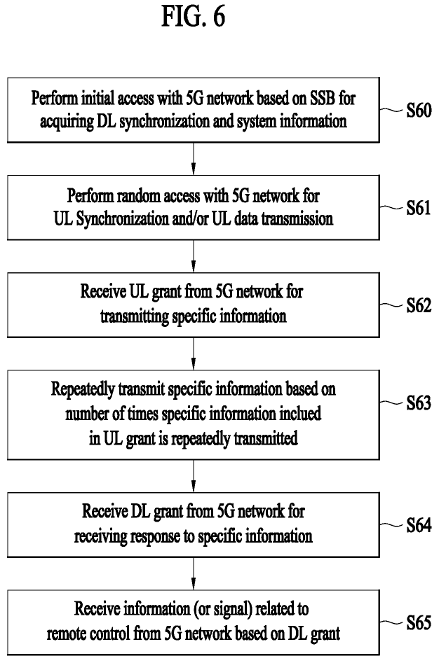

Referring to FIG. 6, in step S60, the autonomous vehicle performs an initial access process with the 5G network based on an SSB to acquire DL synchronization and system information.

In step S61, the autonomous vehicle performs a random access process with the 5G network in order to acquire UL synchronization and/or to transmit UL data.

In step S62, the autonomous vehicle receives an UL grant from the 5G network in order to transmit specific information.

In step S63, the UL grant includes information on the number of times the transmission of specific information is repeated, and the specific information is repeatedly transmitted based on the information on the number of repetition times.

The autonomous vehicle transmits specific information to the 5G network based on the UL grant.

The repetitive transmission of the specific information may be performed through frequency hopping. First transmission of the specific information may be implemented from a first frequency resource, and second transmission of the specific information may be implemented from a second frequency resource.

The specific information may be transmitted through the narrowband of six resource blocks or one resource block.

In step S64, the autonomous vehicle receives a DL grant from the 5G network in order to receive a response to the specific information.

In step S65, the autonomous vehicle receives information (or signals) related to remote control from the 5G network based on the DL grant.

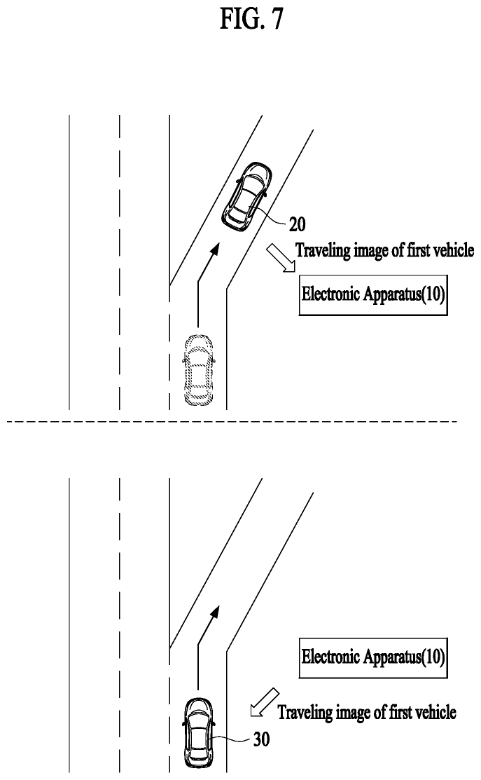

The 5G communication technology described above may be applied in combination with any of the methods proposed by the following description with reference to FIGS. 7 to 19, or may be supplemented to specify or clarify technical features of the methods proposed herein.

FIG. 7 illustrates an example of an operation of an electronic apparatus which provides information to a vehicle.

An electronic apparatus 10 is a device that assists a driver in driving a vehicle conveniently and safely. Specifically, when a specific vehicle is going to travel at an intersection, electronic apparatus 10 may provide the specific vehicle with a traveling image of another vehicle which has first traveled at the intersection in the same route within the same time zone, thereby allowing a driver of the specific vehicle to conveniently receive guidance on the intersection.

In one example, electronic apparatus 10 may be a server which communicates with the vehicle. In another example, electronic apparatus 10 may be an infrastructure such as a road side unit (RSU). In a further example, electronic apparatus 10 may be a vehicle terminal mounted in the vehicle.

Referring to the upper part of FIG. 7, electronic apparatus 10 may acquire a traveling image of a first vehicle 20 associated with traveling at an intersection in a first route. Specifically, first vehicle 20 may enter a highway's exit ramp which is a third lane, and electronic apparatus 10 may acquire, from first vehicle 20, a traveling image of first vehicle 20 which is traveling from a first point to a second point on the exit ramp.

Next, referring to the lower part of FIG. 7, when a second vehicle 30 is going to travel at the intersection in the first route within a predetermined time after first vehicle 20 has traveled at the intersection, electronic apparatus 10 may provide the acquired traveling image of first vehicle 20 to second vehicle 30. In other words, when second vehicle 30 is going to travel on a highway's exit ramp which is a third lane, electronic apparatus 10 may provide second vehicle 30 with the traveling image of first vehicle 20 which has traveled on the exit lamp in the same route within the same time zone.

In this way, by providing second vehicle 30 with the traveling image of first vehicle 20 which has first traveled at the intersection in the same route within the same time zone, electronic apparatus 10 may provide more convenient intersection guidance service than a navigation system which provides intersection guidance service using a consistent image over time. In other words, second vehicle 30 may receive in advance an image showing traveling on the exit ramp as a third lane within the same time zone, so that a driver of second vehicle 30 may receive intersection guidance service based on a traveling image which is most similar to an actual traveling environment. In addition, when traffic congestion occurs on the highway's exit lamp which is a third lane, the driver of second vehicle 30 may check such a traffic congestion situation in advance based on the traveling image of first vehicle 20, and as a result, may try to enter the exit ramp in advance to prevent inconvenience caused by the interruption of another vehicle in the future. In addition, second vehicle 30 may be an autonomous vehicle, and when checking a traffic congestion situation in advance based on the traveling image of first vehicle 20, second vehicle 30 may enter the exit ramp in advance to prevent inconvenience caused by the interruption of another vehicle in the future.

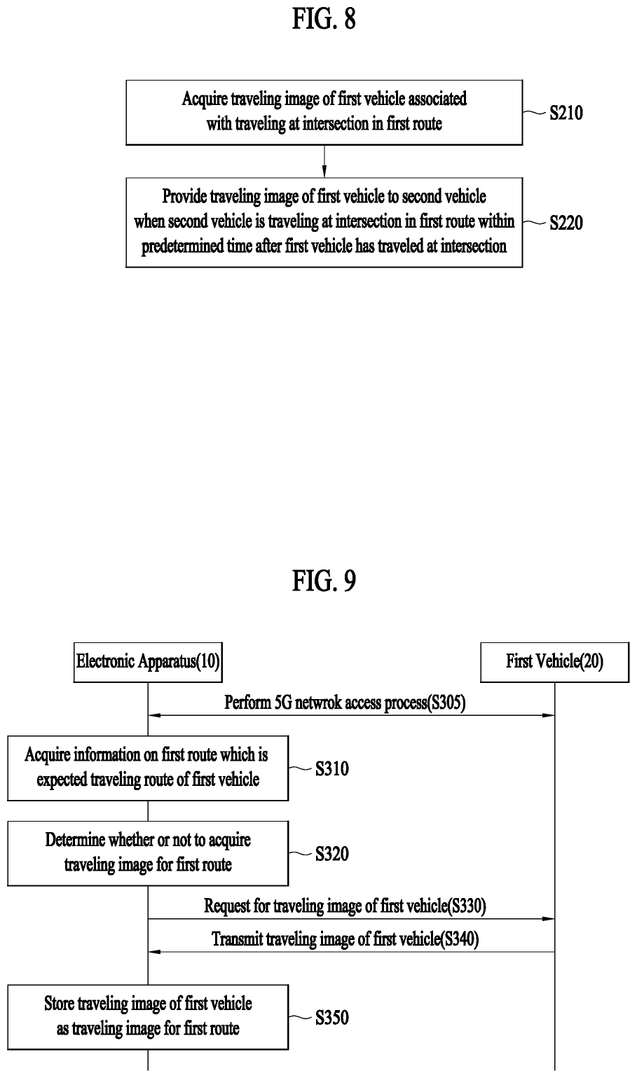

FIG. 8 illustrates a flowchart of a method of providing information to a vehicle from an electronic apparatus.

In step S210, electronic apparatus 10 may acquire a traveling image of a first vehicle associated with traveling at an intersection in a first route. Specifically, electronic apparatus 10 may receive, from the first vehicle, a traveling image of the first vehicle which is traveling from a first point in the first route to a second point in the first route.

The traveling image is an image related to a traveling environment around a vehicle. For example, the traveling image of the first vehicle may be an image obtained when a photographing device of the first vehicle captures an image of a traveling environment around the first vehicle while the first vehicle is traveling. An intersection is a road where two or more roads meet and intersect. Such an intersection may be a forked road including multiple ways such as the entrance way and the exit way, or may be any of other similar types of roads.

Electronic apparatus 10 may receive the traveling image of the first vehicle from the first vehicle based on vehicle-to-infrastructure (V2I) wireless communication or vehicle-to-network (V2N) wireless communication.

FIG. 9 illustrates a flowchart of a method of acquiring a traveling image of a vehicle by an electronic apparatus.

In step S305, electronic apparatus 10 may perform a 5G network access process with first vehicle 20. Specifically, electronic apparatus 10 may perform the 5G network access process illustrated in FIGS. 1 to 6.

In step S310, electronic apparatus 10 may acquire information on a first route which is an expected traveling route of first vehicle 20 at an intersection. For example, electronic apparatus 10 may be connected to first vehicle 20 through a 5G network, and in this case, electronic apparatus 10 may acquire, from first vehicle 20, information on the first route based on an uplink grant.

Electronic apparatus 10 may transmit map data on the intersection to first vehicle 20. The map data may include intersection identification information, intersection location information, identification information for each lane at the intersection, and location information for each lane at the intersection. For example, the map data may be data in a J-2945 V2X standard message form. In addition, electronic apparatus 10 may transmit a message requesting for identification information of first vehicle 20 to first vehicle 20. For example, when first vehicle 20 is located within a predetermined distance from the reference position of the intersection, electronic apparatus 10 may request for identification information of first vehicle 20 and may transmit a message including the map data on the intersection to first vehicle 20.

First vehicle 20 may transmit information on the first route which is an expected traveling route to electronic apparatus 10 based on the map data. For example, first vehicle 20 may transmit information on the start point and the end point of the first route or identification information of a lane included in the first route to electronic apparatus 10. In addition, first vehicle 20 may transmit identification information of first vehicle 20 to electronic apparatus 10.

In step S320, electronic apparatus 10 may determine whether or not to acquire a traveling image for the first route which is an expected traveling route of first vehicle 20.

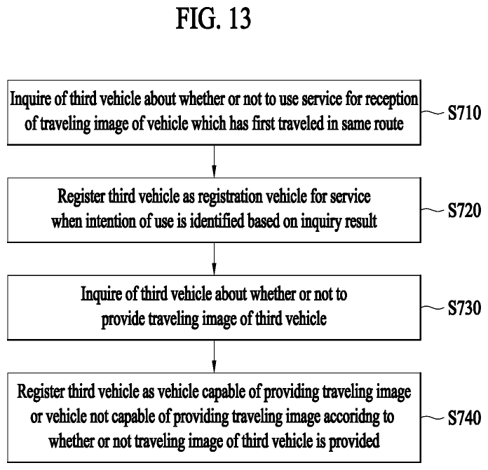

Electronic apparatus 10 may check whether or not first vehicle 20 is a vehicle registered at a service for the reception of a traveling image of a vehicle which has first traveled in the same route by checking the identification information of first vehicle 20. When first vehicle 20 is not registered at the aforementioned service, electronic apparatus 10 may perform a registration process in accordance with FIG. 13. In addition, electronic apparatus 10 may check whether or not first vehicle 20 is registered as a vehicle capable of providing a traveling image by checking the identification information of first vehicle 20. When first vehicle 20 is not the vehicle capable of providing a traveling image, electronic apparatus 10 may perform a registration process in accordance with FIG. 13.

Electronic apparatus 10 may check the storage time of a traveling image which is stored for each route at the intersection. Specifically, electronic apparatus 10 may store a traveling image for each route at the intersection, and may determine whether or not the storage time of the traveling image exceeds a predetermined time. For example, electronic apparatus 10 may determine whether or not the storage time of the traveling image for the first route at the intersection exceeds 30 minutes. Electronic device 10 may determine whether or not the storage time for the first route among routes at the intersection exceeds a predetermined time, and may determine to acquire a traveling image for the first route when the storage time exceeds the predetermined time.

In step S330, when it is determined to acquire the traveling image for the first route, electronic apparatus 10 may transmit a message requesting for a traveling image of first vehicle 20 to first vehicle 20. In addition, electronic apparatus 10 may transmit a message requesting for location information and a traveling image of first vehicle 20 to first vehicle 20. In addition, electronic apparatus 10 may transmit a message requesting for a traveling image to first vehicle 20 when first vehicle 10 passes through a first point in the first route, and may transmit a message indicating that the acquisition of the traveling image has been completed to first vehicle 20 when first vehicle 20 passes through a second point in the first route.

Electronic apparatus 10 may be connected to first vehicle 20 through a 5G network, and in this case, electronic apparatus 10 may transmit the message requesting for the traveling image of first vehicle 10 to first vehicle 20 based on a downlink grant.

In step S340, first vehicle 20 may transmit the traveling image of first vehicle 20 for the first route to electronic apparatus 10. In addition, first vehicle 20 may transmit location information and the traveling image of first vehicle 20 to electronic apparatus 10. For example, first vehicle 20 may capture, as the traveling image, an image of the peripheral environment of first vehicle 20 while traveling from the first point in the first route to the second point in the first route, and may transmit both the captured traveling image for the first route and the location information of first vehicle 20 to electronic apparatus 10

Electronic apparatus 10 may acquire the traveling image of first vehicle 20 for the first route based on an uplink grant.

In step S350, electronic apparatus 10 may store the transmitted traveling image of first vehicle 20 as the traveling image for the first route. Specifically, electronic apparatus 10 may replace a pre-stored traveling image for the first route with the traveling image of first vehicle 20 to update the traveling image for the first route. In one example, electronic apparatus 10 may store the traveling image of first vehicle 20 as the traveling image for the first route in a database inside or outside thereof. In addition, when storing the traveling image of first vehicle 20 as the traveling image for the first route, electronic apparatus 10 may newly count the storage time of the traveling image for the first route. For example, electronic apparatus 10 may newly count the storage time of the traveling image for the first route from the time point at which first vehicle 20 passes through the second point in the first route.

In this way, electronic apparatus 10 may update a traveling image stored for each route at an intersection using a traveling image of a vehicle which enters the intersection when the storage time of the traveling image stored for each route at the intersection exceeds a predetermined time, thereby storing and maintaining a traveling image in the latest time zone for each route at the intersection.

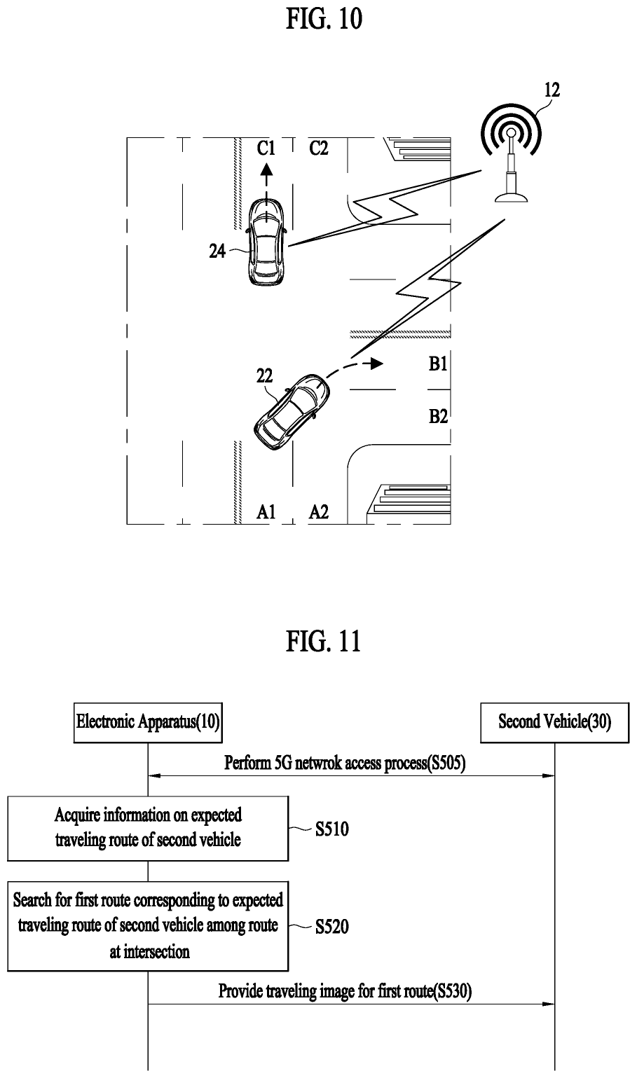

FIG. 10 illustrates a concrete embodiment in which an infrastructure acquires a traveling image of a vehicle.

An infrastructure 12 may acquire a traveling image of a vehicle 22 which is shifting from a lane A1 to a lane B1 at an intersection of FIG. 10. Infrastructure 12 may be one embodiment of electronic apparatus 10. For example, infrastructure may be an RSU.

When vehicle 22 enters the intersection, infrastructure 12 may transmit map data on the intersection to vehicle 22. Next, vehicle 22 may transmit information on an expected traveling route to infrastructure 12 based on the map data. For example, vehicle 22 may transmit information on the lane A1 and the lane B1 included in the expected traveling route to infrastructure 12 based on the map data.

Infrastructure 12 may determine whether or not to acquire a traveling image of vehicle 22 which is traveling in an A1-B1 route in which the vehicle shifts from the lane A1 to the lane B1. Specifically, infrastructure 12 may determine to acquire a traveling image of vehicle 22 when the storage time of a pre-stored traveling image of another vehicle for the A1-B1 route exceeds a predetermined time.

Infrastructure 12 may transmit a message requesting for a traveling image of vehicle 22 to vehicle 22, and vehicle 22 may transmit a traveling image of vehicle 22 to infrastructure 12 in response to the message. Next, infrastructure 12 may store the traveling image of vehicle 22, which is traveling in the A1-B1 route, as the traveling image for the A1-B1 route. In other words, infrastructure 12 may replace the traveling image of the other vehicle for the A1-B1 route with the traveling image of vehicle 22 to update the traveling image for the A1-B1 route.

Similarly, infrastructure 12 may acquire a traveling image of a vehicle 24 which is shifting from lane A1 to a lane C1 at the intersection to update a traveling image for an A1-C1 route.

Referring again to FIG. 8, in step S220, when the second vehicle is traveling at the intersection in the first route within a predetermined time after the first vehicle has traveled at the intersection, electronic apparatus 10 may provide the traveling image of the first vehicle to the second vehicle. In other words, electronic apparatus 10 may provide the second vehicle with the traveling image of the first vehicle which has first traveled at the intersection in the same route within the same time zone. For example, when the second vehicle passes through a first point in the first route within a predetermined time after the first vehicle has passed through a second point, subsequent to the first point, in the first route, electronic apparatus 10 may provide a traveling image of the first vehicle to the second vehicle.

Electronic apparatus 10 may transmit the traveling image of the first vehicle to the second vehicle based on vehicle-to-infrastructure (V2I) wireless communication or vehicle-to-network (V2N) wireless communication.

FIG. 11 illustrates a flowchart of a method of providing a traveling image of a vehicle from an electronic apparatus.

In step S505, electronic apparatus 10 may perform a 5G network access process with second vehicle 30. Specifically, electronic apparatus 10 may perform the 5G network access process illustrated in FIGS. 1 to 6.

In step S510, electronic apparatus 10 may acquire information on an expected traveling route of second vehicle 30. For example, electronic apparatus 10 may be connected to second vehicle 30 through a 5G network, and in this case, electronic apparatus 10 may acquire, from second vehicle 30, information on the expected traveling route of second vehicle 30 based on an uplink grant. Specifically, electronic apparatus 10 may transmit map data on the intersection to second vehicle 30, and second vehicle 30 may transmit identification information on the expected traveling route to electronic apparatus 10 based on the map data. In addition, second vehicle 30 may transmit identification information of second vehicle 30 to electronic apparatus 10 in response to a request of electronic apparatus 10.

Electronic apparatus 10 may check whether or not second vehicle 30 is a vehicle registered at a service for the reception of a traveling image of a vehicle which has first traveled in the same route by checking the identification information of second vehicle 30. When second vehicle 30 is not registered at the aforementioned service, electronic apparatus 10 may perform a registration process in accordance with FIG. 13.

In step S520, electronic apparatus 10 may search for a first route corresponding to the expected traveling route of second vehicle 30 among routes at the intersection based on the acquired expected traveling route of second vehicle 30. Specifically, electronic apparatus 10 may search for a first route which matches the identification information of the expected traveling route based on the map data among the routes at the intersection which are stored in a database.

In step S530, electronic apparatus 10 may provide a traveling image for the first route to second vehicle 30. Specifically, electronic apparatus 10 may transmit a traveling image for the first route, stored in the database, to second vehicle 30. The traveling image for the first route may be a traveling image of the first vehicle which has first traveled at the intersection in the first route. For example, electronic apparatus 10 may provide second vehicle 30 with the traveling image for the first route by a streaming method. In other words, electronic apparatus 10 may provide second vehicle 30 with the traveling image for the first route which is played back in real time. In addition, electronic apparatus 10 may provide the traveling image for the first route to second vehicle 30 from the time point at which second vehicle 30 passes through a predetermined point in the first route.

Electronic apparatus 10 may be connected to second vehicle 30 through a 5G network, and in this case, electronic apparatus 10 may provide the traveling image for the first route to second vehicle 30 based on a downlink grant.

Electronic apparatus 10 may increase the playback speed of the traveling image for the first route when the traffic in the first route is in a congested state, and may provide second vehicle 30 with the traveling image, the playback speed of which has been increased. Thus, second vehicle 30 may check a traffic congestion situation in advance by checking the traveling image for the first route within the same time zone.

Second vehicle 30 may acquire the traveling image for the first route provided from electronic apparatus 10 through a communication unit provided therein, and may display the traveling image for the first route on a display unit provided therein.

In addition, second vehicle 30 may be an autonomous vehicle. Thus, second vehicle 30 may autonomously travel with reference to the traveling image for the first route provided from electronic apparatus 10. Specifically, second vehicle 30 may reset an expected traveling route with reference to a traveling image of the first vehicle which has traveled in the same route as the expected traveling route within the same time zone, and may travel in the reset traveling route. For example, second vehicle 30 may check traffic congestion in the expected traveling route from the traveling image of the first vehicle, and may correct a part of the expected traveling route during traveling.

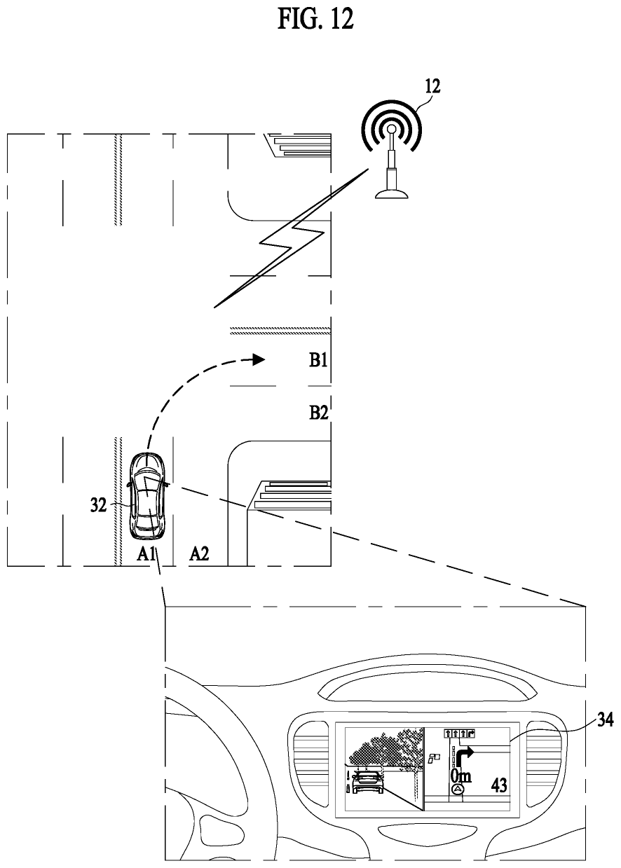

FIG. 12 illustrates a concrete embodiment in which an infrastructure provides a traveling image of a vehicle.

When a vehicle 32 enters an intersection of FIG. 12, infrastructure 12 may acquire information on an expected traveling route of vehicle 32. Specifically, infrastructure 12 may transmit map data on the intersection to vehicle 32. Next, vehicle 32 may transmit information on an expected traveling route to infrastructure 12 based on the map data. For example, vehicle 32 may transmit identification information on the A1-B1 route which is the expected traveling route to infrastructure 12 based on the map data.

Infrastructure 12 may search for the A1-B1 route as a route corresponding to the expected traveling route of vehicle 32 among routes at the intersection which are stored in a database, and may search for a traveling image for the A1-B1 route among traveling images stored in the database. Next, infrastructure 12 may provide the traveling image for the searched A1-B1 route to vehicle 32.

Vehicle 32 may receive the traveling image for the A1-B1 route from infrastructure 12. Specifically, vehicle 32 may display the traveling image for the A1-B1 route on a display unit 34 inside vehicle 32. For example, referring to FIG. 12, display unit 34 may display a screen showing the A1-B1 route, executed by a navigation system, on the right side, and at the same time, may display the traveling image for the A1-B1 route, provided from infrastructure 12, on the left side. Thus, a driver in vehicle 32 may conveniently receive intersection guidance service. In addition, display unit 34 may increase the playback speed of the traveling image for the A1-B1 route, and may display the traveling image, the playback speed of which has been increased. As a result, the driver in vehicle 32 may check traffic congestion in the A1-B1 route, and may try to travel at the intersection in another route.

FIG. 13 illustrates a flowchart of registering a vehicle as a registration vehicle for a service by an electronic apparatus.

In step S710, electronic apparatus 10 may inquire of a third vehicle about whether or not to use a service for the reception of a traveling image of a vehicle which has first traveled in the same route. Electronic apparatus 10 may transmit a message inquiring whether or not to use the service to the third vehicle. In one example, electronic apparatus 10 may transmit a message inquiring whether or not to use the service to the third vehicle which is entering an intersection. In another example, electronic apparatus 10 may transmit a message inquiring whether or not to use a plug-in-type service of a navigation system to the third vehicle when the navigation system of the third vehicle is operated.

In step S720, when the intention of using the service from the third vehicle is identified as the inquiry result of step S710, electronic apparatus 10 may register the third vehicle as a registration vehicle for the service. Specifically, electronic apparatus 10 may receive a message indicating the intention of using the service from the third vehicle, and may generate a service registration ID to give the service registration ID to the third vehicle.

In step S730, electronic apparatus 10 may inquire of the third vehicle about whether or not to provide a traveling image of the third vehicle. Specifically, electronic apparatus 10 may transmit, to the third vehicle, a message inquiring whether or not the third vehicle is willing to provide a traveling image of the third vehicle for other vehicles.

In step S740, electronic apparatus 10 may register the third vehicle as a vehicle capable of providing a traveling image or a vehicle not capable of providing a traveling image according to whether or not the traveling image of the third vehicle is provided. Specifically, electronic apparatus 10 may register the third vehicle as a vehicle capable of providing a traveling image when the third vehicle as a registration vehicle for the service agrees to provide a traveling image based on the inquiry result of step S730. On the contrary, electronic apparatus 10 may register the third vehicle as a vehicle not capable of providing a traveling image when the third vehicle as a registration vehicle for the service does not agree to provide a traveling image based on the inquiry result of step S730. When the third vehicle is registered as a vehicle capable of providing a traveling image, the third vehicle may receive a traveling image of a vehicle which has first traveled at the intersection in the same route when traveling at the intersection, and may provide a traveling image of the third vehicle to electronic apparatus 10 for other vehicles. In addition, when the third vehicle is registered as a vehicle not capable of providing a traveling image, the third vehicle may receive a traveling image of a vehicle which has first traveled at the intersection in the same route when traveling at the intersection, but may not provide a traveling image of the third vehicle to electronic apparatus 10 for other vehicles.

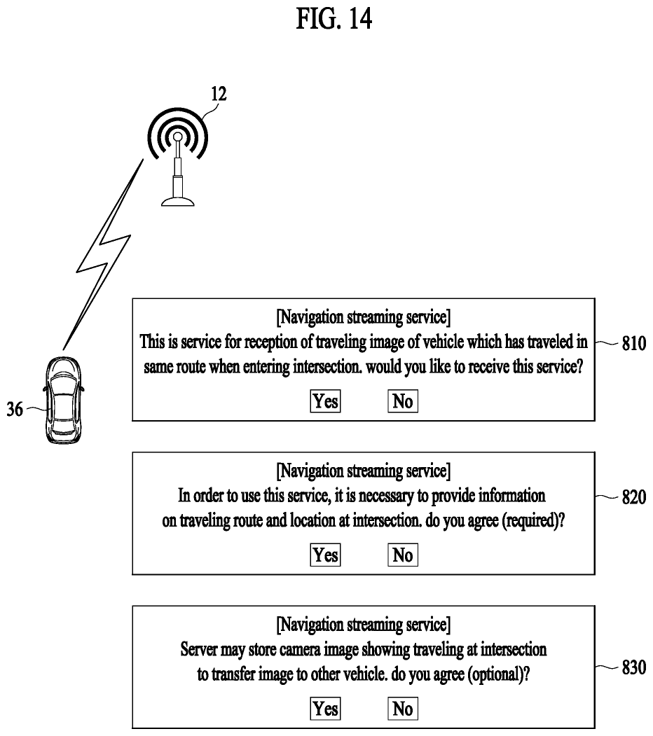

FIG. 14 illustrates a concrete embodiment in which an infrastructure registers a vehicle as a registration vehicle for a service.

Infrastructure 12 may transmit a message 810 inquiring of a vehicle 36 about whether or not to use a navigation streaming service for the reception of a traveling image of a vehicle which has traveled at an intersection in the same route when vehicle 36 enters the intersection. In addition, infrastructure 12 may transmit, along with message 810, a message 820 inquiring whether or not to agree to the provision of information on a traveling route and a traveling location of vehicle 36 for using the navigation streaming service.

Vehicle 36 may transmit a message indicating the intention of using the navigation streaming service and the intention of agreeing to the provision of information on the traveling route and the traveling location to infrastructure 12 in response to messages 810 and 820. For example, a driver in vehicle 36 may respond to messages 810 and 820 via an input unit inside vehicle 36, and vehicle 36 may transmit a message 830 indicating the intention of use and the intention of agreement to infrastructure 12 in response to messages 810 and 820. In this case, infrastructure 12 may additionally transmit, to vehicle 36, a message 830 inquiring whether or not to provide a traveling image of vehicle 36. Vehicle 36 may be registered as a vehicle capable of providing a traveling image when agreeing to provide a traveling image in response to message 830, and may be registered as a vehicle not capable of providing a traveling image when not agreeing.

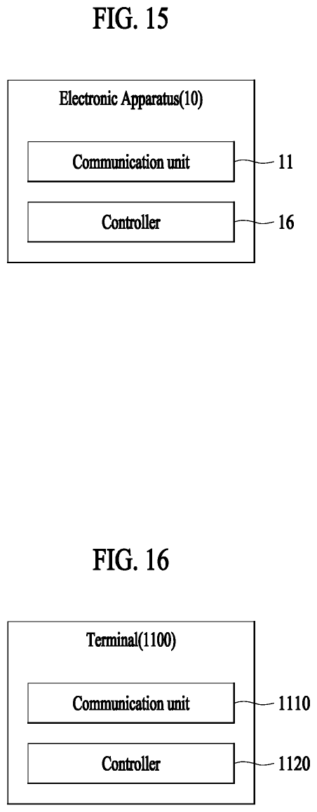

FIG. 15 illustrates a block diagram of an electronic apparatus which provides information to a vehicle.

Electronic apparatus 10 may include a communication unit 11 and a controller 16 according to one embodiment. In FIG. 15, only components of electronic apparatus 10 associated with the present embodiment are illustrated. Thus, it will be understood by those skilled in the art that the electronic apparatus may include common components other than the components illustrated in FIG. 15.

Communication unit 11 may communicate with a first vehicle and a second vehicle. In this case, a communication technology used by communication unit 11 may be, for example, a global system for mobile communication (GSM), a code division multi-access (CDMA), long term evolution (LTE), 5G, wireless LAN (WLAN), wireless-fidelity (Wi-Fi), Bluetooth™, radio frequency identification (RFID), infrared data association (IrDA), ZigBee, or near field communication (NFC).

In addition, communication unit 11 may communicate with the first vehicle and the second vehicle based on vehicle-to-infrastructure (V2I) wireless communication or vehicle-to-network (V2N) wireless communication.

Controller 16 may control a general operation of electronic apparatus 10 and may process data and signals. Controller 16 may be configured as at least one hardware unit. In addition, controller 16 may be operated by one or more software models which are generated by executing a program code stored in a memory.

Controller 16 may acquire a traveling image of the first vehicle associated with traveling at an intersection in a first route through communication unit 11. Controller 16 may perform a 5G network access process with the first vehicle and may also acquire the traveling image of the first vehicle based on an uplink grant through communication unit 11.

Controller 16 may acquire information on the first route which is an expected traveling route of the first vehicle at the intersection. Controller 16 may transmit map data on the intersection to the first vehicle, and may acquire information on the first route which is the expected traveling route from the first vehicle based on the map data. In addition, controller 16 may transmit a message requesting for identification information of the first vehicle to the first vehicle, and may acquire identification information of the first vehicle from the first vehicle.

Controller 16 may check whether or not the first vehicle is a vehicle registered at a service for the reception of a traveling image of a vehicle which has first traveled in the same route by checking the identification information of the first vehicle. In addition, controller 16 may check whether or not the first vehicle is registered as a vehicle capable of providing a traveling image by checking the identification information of the first vehicle.

Controller 16 may check the storage time of a traveling image which is stored for each route at the intersection, and may determine whether or not the storage time of the traveling image exceeds a predetermined time. Controller 16 may determine whether or not the storage time for the first route among routes at the intersection exceeds a predetermined time, and may determine to acquire a traveling image for the first route when the storage time exceeds the predetermined time.

When it is determined to acquire the traveling image for the first route, controller 16 may transmit a message requesting for the traveling image of the first vehicle to the first vehicle. Next, controller 16 may acquire the traveling image for the first route from the first vehicle. Specifically, controller 16 may replace a pre-stored traveling image for the first route with the traveling image of the first vehicle to update the traveling image for the first route.

When the second vehicle is traveling at the intersection in the first route within a predetermined time after the first vehicle has traveled at the intersection, controller 16 may provide the traveling image of the first vehicle to the second vehicle through communication unit 11. Controller 16 may perform a 5G network access process with the second vehicle and may also provide the traveling image of the first vehicle to the second vehicle based on a downlink grant through communication unit 11.

Controller 16 may acquire information on an expected traveling route of the second vehicle. Specifically, controller 16 may transmit map data on the intersection to the second vehicle, and controller 16 may acquire identification information on the expected traveling route from the second vehicle based on the map data.

Controller 16 may acquire identification information of the second vehicle from the second vehicle. Controller 16 may check whether or not the second vehicle is a vehicle registered at a service for the reception of a traveling image of a vehicle which has first traveled in the same route by checking the identification information of the second vehicle. When the second vehicle is not a vehicle registered at the service, controller 16 may perform the registration process in accordance with FIG. 13.

Controller 16 may search for the first route corresponding to the expected traveling route of the second vehicle among routes at the intersection based on the acquired expected traveling route of the second vehicle. Next, controller 16 may provide the traveling image for the first route to the second vehicle.

Controller 16 may increase the playback speed of the traveling image for the first route when the traffic in the first route is in a congested state, and may provide the second vehicle with the traveling image, the playback speed of which has been increased.

Controller 16 may inquire of a third vehicle about whether or not to use a service for the reception of a traveling image of a vehicle which has first traveled at the intersection in the same route. When the intention of using the service by the third vehicle is identified based on the inquiry result, controller 16 may register the third vehicle as a registration vehicle for the service.

Controller 16 may inquire of the third vehicle about whether or not to provide a traveling image of the third vehicle. Controller 16 may register the third vehicle as a vehicle capable of providing a traveling image or a vehicle not capable of providing a traveling image based on whether or not the traveling image of the third vehicle is provided.

FIG. 16 illustrates a block diagram of a terminal which assists vehicle driving.

A terminal 1100 may be a device that is disposed inside a vehicle to assist a driver in driving the vehicle. In one embodiment, terminal 1100 may include a communication unit 1110 and a controller 1120. In FIG. 16, only components of terminal 1100 associated with the present embodiment are illustrated. Thus, it will be understood by those skilled in the art that the terminal may include common components other than the components illustrated in FIG. 16.

Communication unit 1110 may communicate with an external electronic apparatus. The external electronic apparatus may be a server that communicates with another vehicle, or may be an infrastructure such as a road side unit (RSU). Communication unit 1110 may communicate with an external device based on vehicle-to-infrastructure (V2I) wireless communication or vehicle-to-network (V2N) wireless communication.

In addition, a communication technology used by communication unit 1110 may be, for example, a global system for mobile communication (GSM), a code division multi-access (CDMA), long term evolution (LTE), 5G, wireless LAN (WLAN), wireless-fidelity (Wi-Fi), Bluetooth™, radio frequency identification (RFID), infrared data association (IrDA), ZigBee, or near field communication (NFC).

When the vehicle is traveling at an intersection in a first route within a predetermined time after the other vehicle has traveled at the intersection in the first route, controller 1120 may acquire a traveling image of the other vehicle, showing that the other vehicle has traveled at the intersection in the first route, through communication unit 1110.

Controller 1120 may control a display unit to display the acquired traveling image of the other vehicle.

In addition, the vehicle may be an autonomous vehicle, and controller 1120 may control the vehicle to autonomously drive with reference to the acquired traveling image of the other vehicle. For example, controller 1120 may set a traveling route with reference to the acquired traveling image of the other vehicle, and may control the vehicle to travel in the set traveling route.

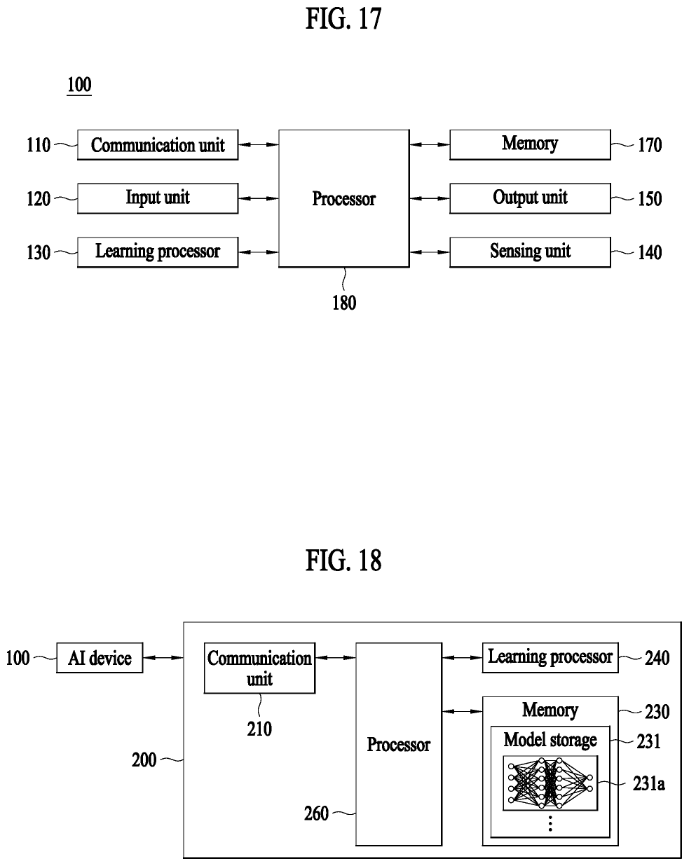

FIG. 17 illustrates an AI device according to an embodiment.

An AI device 100 may be realized into, for example, a stationary appliance or a movable appliance, such as a TV, a projector, a cellular phone, a smart phone, a desktop computer, a laptop computer, a digital broadcasting terminal, a personal digital assistant (PDA), a portable multimedia player (PMP), a navigation system, a tablet PC, a wearable device, a set-top box (STB), a refrigerator, a digital signage, a robot, a vehicle, or an XR device. In addition, AI device 100 may be implemented into electronic apparatus 10 of FIGS. 7 to 15. In addition, AI device 100 may be implemented in terminal 1100 of FIG. 16.

Referring to FIG. 17, AI device 100 may include a communication unit 110, an input unit 120, a learning processor 130, a sensing unit 140, an output unit 150, a memory 170, and a processor 180, for example.

Communication unit 110 may transmit and receive data to and from external devices, such as other AI devices 100a to 100e and an AI server 200, using wired/wireless communication technologies. For example, communication unit 110 may transmit and receive sensor information, user input, learning models, and control signals, for example, to and from external devices.

At this time, the communication technology used by communication unit 110 may be, for example, a global system for mobile communication (GSM), code division multiple Access (CDMA), long term evolution (LTE), 5G, wireless LAN (WLAN), wireless-fidelity (Wi-Fi), Bluetooth™, radio frequency identification (RFID), infrared data association (IrDA), ZigBee, or near field communication (NFC).

Input unit 120 may acquire various types of data.

At this time, input unit 120 may include a camera for the input of an image signal, a microphone for receiving an audio signal, and a user input unit for receiving information input by a user, for example. Here, the camera or the microphone may be handled as a sensor, and a signal acquired from the camera or the microphone may be referred to as sensing data or sensor information.

Input unit 120 may acquire, for example, input data to be used when acquiring an output using learning data for model learning and a learning model. Input unit 120 may acquire unprocessed input data, and in this case, processor 180 or learning processor 130 may extract an input feature as pre-processing for the input data.

Learning processor 130 may cause a model configured with an artificial neural network to learn using the learning data. Here, the learned artificial neural network may be called a learning model. The learning model may be used to deduce a result value for newly input data other than the learning data, and the deduced value may be used as a determination base for performing any operation.

At this time, learning processor 130 may perform AI processing along with a learning processor 240 of AI server 200.

At this time, learning processor 130 may include a memory integrated or embodied in AI device 100. Alternatively, learning processor 130 may be realized using memory 170, an external memory directly coupled to AI device 100, or a memory held in an external device.

Sensing unit 140 may acquire at least one of internal information of AI device 100 and surrounding environmental information and user information of AI device 100 using various sensors.

At this time, the sensors included in sensing unit 140 may be a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar, for example.

Output unit 150 may generate, for example, a visual output, an auditory output, or a tactile output.

At this time, output unit 150 may include, for example, a display that outputs visual information, a speaker that outputs auditory information, and a haptic module that outputs tactile information.

Memory 170 may store data which assists various functions of AI device 100. For example, memory 170 may store input data acquired by input unit 120, learning data, learning models, and learning history, for example.

Processor 180 may determine at least one executable operation of AI device 100 based on information determined or generated using a data analysis algorithm or a machine learning algorithm. Then, processor 180 may control constituent elements of A1 device 100 to perform the determined operation.

To this end, processor 180 may request, search, receive, or utilize data of learning processor 130 or memory 170, and may control the constituent elements of AI device 100 so as to execute a predictable operation or an operation that is deemed desirable among the at least one executable operation.

At this time, when connection of an external device is necessary to perform the determined operation, processor 180 may generate a control signal for controlling the external device and may transmit the generated control signal to the external device.

Processor 180 may acquire intention information with respect to user input and may determine a user request based on the acquired intention information.

At this time, processor 180 may acquire intention information corresponding to the user input using at least one of a speech to text (STT) engine for converting voice input into a character string and a natural language processing (NLP) engine for acquiring natural language intention information.

At this time, at least a part of the STT engine and/or the NLP engine may be configured with an artificial neural network learned according to a machine learning algorithm. Then, the STT engine and/or the NLP engine may have learned by learning processor 130, may have learned by learning processor 240 of AI server 200, or may have learned by distributed processing of processors 130 and 240.

Processor 180 may collect history information including, for example, the content of an operation of AI device 100 or feedback of the user with respect to an operation, and may store the collected information in memory 170 or learning processor 130, or may transmit the collected information to an external device such as AI server 200. The collected history information may be used to update a learning model.

Processor 180 may control at least some of the constituent elements of AI device 100 in order to drive an application program stored in memory 170. Moreover, processor 180 may combine and operate two or more of the constituent elements of AI device 100 for the driving of the application program.

FIG. 18 illustrates an AI server according to an embodiment.

Referring to FIG. 18, an AI server 200 may refer to a device that causes an artificial neural network to learn using a machine learning algorithm or uses the learned artificial neural network. Here, AI server 200 may be constituted of multiple servers to perform distributed processing, and may be defined as a 5G network. At this time, AI server 200 may be included as a constituent element of AI device 100 so as to perform at least a part of AI processing together with AI device 100.

AI server 200 may include a communication unit 210, a memory 230, a learning processor 240, and a processor 260, for example.

Communication unit 210 may transmit and receive data to and from an external device such as AI device 100.

Memory 230 may include a model storage unit 231. Model storage unit 231 may store a model (or an artificial neural network) 231a which is learning or has learned via learning processor 240.

Learning processor 240 may cause artificial neural network 231a to learn learning data. A learning model may be used in the state of being mounted in AI server 200 of the artificial neural network, or may be used in the state of being mounted in an external device such as AI device 100.

The learning model may be realized in hardware, software, or a combination of hardware and software. In the case in which a part or the entirety of the learning model is realized in software, one or more instructions constituting the learning model may be stored in memory 230.

Processor 260 may deduce a result value for newly input data using the learning model, and may generate a response or a control instruction based on the deduced result value.

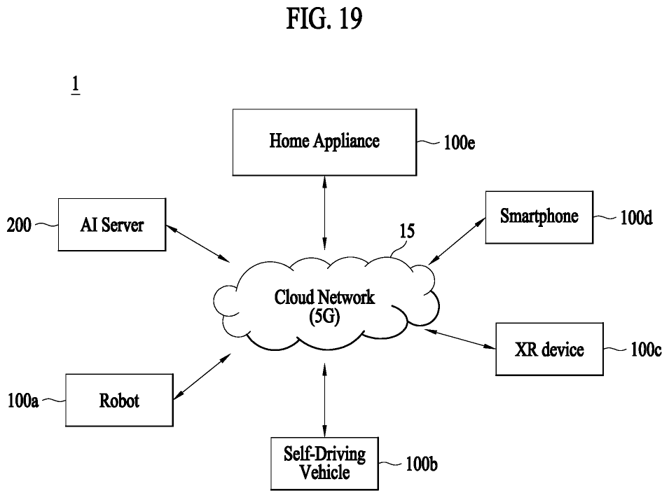

FIG. 19 illustrates an AI system according to an embodiment.

Referring to FIG. 19, in an AI system 1, at least one of AI server 200, a robot 100a, an autonomous vehicle 100b, an XR device 100c, a smart phone 100d, and a home appliance 100e is connected to a cloud network 15. Here, robot 100a, autonomous vehicle 100b, XR device 100c, smart phone 100d, and home appliance 100e, to which A1 technologies are applied, may be referred to as AI devices 100a to 100e. In addition, autonomous vehicle 100b may be any one of the vehicles illustrated in FIGS. 7 to 16.

Cloud network 15 may constitute a part of a cloud computing infra-structure, or may mean a network present in the cloud computing infra-structure. Here, cloud network 15 may be configured using a 3G network, a 4G or long term evolution (LTE) network, or a 5G network, for example.

That is, respective devices 100a to 100e and 200 constituting AI system 1 may be connected to each other via cloud network 15. In particular, respective devices 100a to 100e and 200 may communicate with each other via a base station, or may perform direct communication without the base station.

AI server 200 may include a server which performs AI processing and a server which performs an operation with respect to big data.

AI server 200 may be connected to at least one of robot 100a, autonomous vehicle 100b, XR device 100c, smart phone 100d, and home appliance 100e, which are A1 devices constituting AI system 1, via cloud network 15, and may assist at least a part of AI processing of connected AI devices 100a to 100e.

At this time, instead of AI devices 100a to 100e, AI server 200 may cause an artificial neural network to learn according to a machine learning algorithm, and may directly store a learning model or may transmit the learning model to AI devices 100a to 100e.

At this time, AI server 200 may receive input data from AI devices 100a to 100e, may deduce a result value for the received input data using the learning model, and may generate a response or a control instruction based on the deduced result value to transmit the response or the control instruction to AI devices 100a to 100e.

Alternatively, AI devices 100a to 100e may directly deduce a result value with respect to input data using the learning model, and may generate a response or a control instruction based on the deduced result value.

AI devices 100a to 100e illustrated in FIG. 19 may be concrete embodiments of A1 device 100 illustrated in FIG. 17.

Autonomous vehicle 100b may be realized into a mobile robot, a vehicle, or an unmanned air vehicle, for example, through the application of A1 technologies.

Autonomous vehicle 100b may include an autonomous driving control module for controlling an autonomous driving function, and the autonomous driving control module may mean a software module or a chip realized in hardware. The autonomous driving control module may be a constituent element included in autonomous vehicle 100b, but may be a separate hardware element outside autonomous vehicle 100b so as to be connected thereto.

Autonomous vehicle 100b may acquire information on the state of autonomous vehicle 100b using sensor information acquired from various types of sensors, may detect (recognize) the surrounding environment and an object, may generate map data, may determine a movement route and a driving plan, or may determine an operation.

Here, autonomous vehicle 100b may use sensor information acquired from at least one sensor among a LIDAR, a radar, and a camera in the same manner as robot 100a in order to determine a movement route and a driving plan.

In particular, autonomous vehicle 100b may recognize the environment or an object with respect to an area outside the field of vision or an area located at a predetermined distance or more by receiving sensor information from external devices, or may directly receive recognized information from external devices.

Autonomous vehicle 100b may perform the above-described operations using a learning model configured with at least one artificial neural network. For example, autonomous vehicle 100b may recognize the surrounding environment and the object using the learning model, and may determine a driving line using the recognized surrounding environment information or object information. Here, the learning model may be directly learned in autonomous vehicle 100b, or may be learned in an external device such as AI server 200.

At this time, autonomous vehicle 100b may generate a result using the learning model to perform an operation, but may transmit sensor information to an external device such as AI server 200 and receive a result generated by the external device to perform an operation.

Autonomous vehicle 100b may determine a movement route and a driving plan using at least one of map data, object information detected from sensor information, and object information acquired from an external device, and a drive unit may be controlled to drive autonomous vehicle 100b according to the determined movement route and driving plan.

The map data may include object identification information for various objects arranged in a space (e.g., a road) along which autonomous vehicle 100b drives. For example, the map data may include object identification information for stationary objects, such as streetlights, rocks, and buildings, and movable objects such as vehicles and pedestrians. Then, the object identification information may include names, types, distances, and locations, for example.

In addition, autonomous vehicle 100b may perform an operation or may drive by controlling the drive unit based on user control or interaction. At this time, autonomous vehicle 1100b may acquire interactional intention information depending on a user operation or voice expression, and may determine a response based on the acquired intention information to perform an operation.

The devices in accordance with the above-described embodiments may include a processor, a memory which stores and executes program data, a permanent storage such as a disk drive, a communication port for communication with an external device, and a user interface device such as a touch panel, a key, and a button. Methods realized by software modules or algorithms may be stored in a computer readable recording medium as computer readable codes or program commands which may be executed by the processor. Here, the computer readable recording medium may be a magnetic storage medium (for example, a read-only memory (ROM), a random-access memory (RAM), a floppy disk, or a hard disk) or an optical reading medium (for example, a CD-ROM or a digital versatile disc (DVD)). The computer readable recording medium may be dispersed to computer systems connected by a network so that computer readable codes may be stored and executed in a dispersion manner. The medium may be read by a computer, may be stored in a memory, and may be executed by the processor.

The present embodiments may be represented by functional blocks and various processing steps. These functional blocks may be implemented by various numbers of hardware and/or software configurations that execute specific functions. For example, the present embodiments may adopt direct circuit configurations such as a memory, a processor, a logic circuit, and a look-up table that may execute various functions by control of one or more microprocessors or other control devices. Similarly to that elements may be executed by software programming or software elements, the present embodiments may be implemented by programming or scripting languages such as C, C++, Java, and assembler including various algorithms implemented by combinations of data structures, processes, routines, or of other programming configurations. Functional aspects may be implemented by algorithms executed by one or more processors. In addition, the present embodiments may adopt the related art for electronic environment setting, signal processing, and/or data processing, for example. The terms “mechanism”, “element”, “means”, and “configuration” may be widely used and are not limited to mechanical and physical components. These terms may include meaning of a series of routines of software in association with a processor, for example.

What is claimed is:

1. A method of providing information to a vehicle from an electronic apparatus, the method comprising:
acquiring a traveling image of a first vehicle associated with traveling at an intersection in a first route; and
providing the traveling image of the first vehicle to a second vehicle when the second vehicle is traveling at the intersection in the first route within a predetermined time after the first vehicle has traveled at the intersection.

2. The method of claim 1, wherein the acquiring includes:
acquiring information on the first route that is an expected traveling route of the first vehicle at the intersection;
determining whether or not to acquire a traveling image for the first route; and
acquiring the traveling image of the first vehicle according to a result of the determining and storing the traveling image of the first vehicle as the traveling image for the first route.

3. The method of claim 2, wherein the acquiring the information on the first route includes:
transmitting map data on the intersection to the first vehicle; and
acquiring the information on the first route based on the map data and identification information of the first vehicle from the first vehicle.

4. The method of claim 2, wherein the acquiring further includes performing a 5G network access process with the first vehicle,
wherein the acquiring the information on the first route includes acquiring the information on the first route from the first vehicle based on an uplink grant, and
wherein the storing includes acquiring the traveling image of the first vehicle from the first vehicle based on the uplink grant.

5. The method of claim 2, wherein the determining includes:
checking a storage time of the traveling image stored for each route at the intersection;
determining whether or not a storage time of a pre-stored traveling image for the first route exceeds a predetermined time; and
determining to acquire the traveling image for the first route when it is determined that the storage time exceeds the predetermined time, and
wherein the storing includes replacing the pre-stored traveling image for the first route with the traveling image of the first vehicle to update the traveling image for the first route.

6. The method of claim 1, wherein the providing includes:
acquiring information on an expected traveling route of the second vehicle;
searching for the first route corresponding to the expected traveling route of the second vehicle among routes at the intersection; and
providing the traveling image of the first vehicle to the second vehicle as the traveling image for the first route.

7. The method of claim 6, wherein the providing further includes performing a 5G network access process with the second vehicle,
wherein the acquiring the information on the expected traveling route of the second vehicle includes acquiring the information on the expected traveling route of the second vehicle from the second vehicle based on an uplink grant, and
wherein the providing includes providing the traveling image of the first vehicle to the second vehicle based on a downlink grant.

8. The method of claim 6, wherein the acquiring the information on the expected traveling route of the second vehicle includes:
transmitting map data on the intersection to the second vehicle; and
acquiring the information on the expected traveling route based on the map data and identification information of the second vehicle from the second vehicle.

9. The method of claim 6, wherein the providing includes increasing a playback speed of the traveling image of the first vehicle when traffic in the first route is in a congested state and providing the traveling image of the first vehicle, the playback speed of which has been increased, to the second vehicle.

10. The method of claim 1, further comprising:
inquiring of a third vehicle about whether or not to use a service for reception of a traveling image of a vehicle which has first traveled in the same route;
registering the third vehicle as a registration vehicle for the service when an intention of use is identified based on a result of the inquiring;
inquiring of the third vehicle about whether or not to provide a traveling image of the third vehicle; and
registering the third vehicle as one of a vehicle capable of providing a traveling image and a vehicle not capable of providing a traveling image according to whether or not the traveling image of the third vehicle is provided.

11. The method of claim 1, wherein the acquiring or the providing is performed based on a vehicle-to-infrastructure (V2I) wireless communication or a vehicle-to-network (V2N) wireless communication.

12. An electronic apparatus that provides information to a vehicle, the electronic apparatus comprising:
a communication unit that communicates with a first vehicle and a second vehicle; and
a controller that acquires a traveling image of the first vehicle associated with traveling at an intersection in a first route through the communication unit, and provides the traveling image of the first vehicle to the second vehicle when the second vehicle is traveling at the intersection in the first route within a predetermined time after the first vehicle has traveled at the intersection.

13. The electronic apparatus of claim 12, wherein the controller performs a 5G network access process with the first vehicle, acquires information on the first route that is an expected traveling route of the first vehicle at the intersection from the first vehicle based on an uplink grant, determines whether or not to acquire a traveling image for the first route, acquires the traveling image of the first vehicle based on the uplink grant according to a result of the determination, and stores the traveling image of the first vehicle as the traveling image for the first route.

14. The electronic apparatus of claim 13, wherein the controller transmits map data on the intersection to the first vehicle, and acquires the information on the first route based on the map data and identification information of the first vehicle from the first vehicle.

15. The electronic apparatus of claim 13, wherein the controller checks a storage time of the traveling image stored for each route at the intersection, determines whether or not a storage time of a pre-stored traveling image for the first route exceeds a predetermined time, determines to acquire the traveling image for the first route when it is determined that the storage time exceeds the predetermined time, and replaces the pre-stored traveling image for the first route with the traveling image of the first vehicle to update the traveling image for the first route.

16. The electronic apparatus of claim 12, wherein the controller performs a 5G network access process with the second vehicle, acquires information on an expected traveling route of the second vehicle from the second vehicle based on an uplink grant, searches for the first route corresponding to the expected traveling route of the second vehicle among routes at the intersection, and provides the traveling image of the first vehicle to the second vehicle as the traveling image for the first route based on a downlink grant.

17. The electronic apparatus of claim 16, wherein the controller transmits map data on the intersection to the second vehicle, and acquires the information on the expected traveling route based on the map data and identification information of the second vehicle from the second vehicle.

18. The electronic apparatus claim 12, wherein the controller inquires of a third vehicle about whether or not to use a service for reception of a traveling image of a vehicle which has first traveled in the same route through the communication unit, registers the third vehicle as a registration vehicle for the service when an intention of use is identified based on a result of the inquiry, inquires of the third vehicle about whether or not to provide a traveling image of the third vehicle, and registers the third vehicle as one of a vehicle capable of providing a traveling image and a vehicle not capable of providing a traveling image according to whether or not the traveling image of the third vehicle is provided.

19. A terminal that assists driving of a vehicle, the terminal comprising:
a communication unit that communicates with an external electronic apparatus; and
a controller that acquires a traveling image of another vehicle associated with traveling at an intersection in a first route through the communication unit when the vehicle is traveling at the intersection in the first route within a predetermined time after the other vehicle has traveled at the intersection, and controls a display unit of the vehicle to display the traveling image of the other vehicle.

20. A computer readable non-volatile recording medium storing a program for executing the method of claim 1 in a computer.
